(19) United States
(12) Patent Application Publication
(10) Pub. No.: US 2004/0196462 A1
(43) Pub. Date: Oct. 7, 2004

(54) Method for coloring plastic by using plastic recycling material

(76) Inventors: Klaus Schultheiss, Furth (DE); Gerhard Schwarz, Nurnberg (DE)

Correspondence Address: Quarles & Brady, 411 East Wisconsin Avenue, Milwaukee, WI, 53202-4497, US

(21) Appl. No.: 10/478,919

(22) PCT Filed: May 18, 2002
(86) PCT No.: PCT/EP02/05511

(30) Foreign Application Priority Data
May 23, 2001 (DE) 10125084.3

(51) Int. Cl. G01J 3/46

(52) U.S. Cl. 356/402; 356/72; 356/425; 250/226

(57) ABSTRACT

The invention relates to a method for coloring plastics. To this end, used plastics are firstly collected before being subsequently sorted. The collected and sorted plastics are ground, and coloring pigments existing in the ground plastics are determined. The target color of the plastic that is to be newly produced is predetermined, and the used ground plastics are mixed in quantities that provide the new plastic with the desired target color.

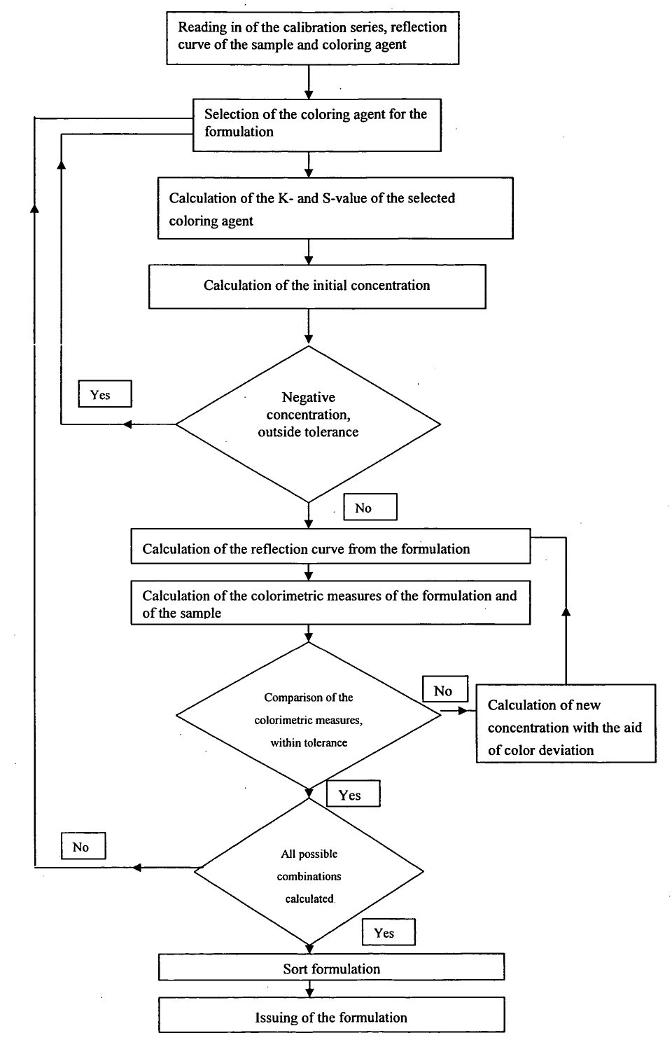

The task of the invention is to provide a method and a device for coloring, in large amounts, structural parts made of plastic using recycled plastic material.

Before processing, plastics are mostly present as a base material with neutral color. Therefore, so-called master batches are used for coloring structural parts made of plastic in the bulk. These master batches are substances which are mixed with the plastic raw material and color it. These master batches have the disadvantage that they are very expensive.

Housing for electronic equipment used in the home, for example, TVs, are characterized by free forms because of the design and they can be produced most easily from plastic material. The injection molding method is used here as a cost-effective production method.

The preparation of master batches is known from WO 98/01498.

A colored polymer is known from EP 0 352 804 A2, which forms a compound with a dye.

A method for coloring plastic granulate is known from EP 0 290 092.

A method for the production of colored plastic powder is known from DE 198 07 261 A1.

A method for the production of a color concentrate for processing in plastic processing machines is known from DE 43 31 167 A1.

A method for obtaining valuable materials from nonvolatile inorganic plastic additives is known from DE 40 26 188 A1. Here, molded objects or waste residues made of plastic are reduced in size and combusted according to known methods. Then the residue obtained from the combustion is processed and used again.

None of the known methods offers a method of using recycled material from old equipment for the production of new equipment, especially housings.

In this connection, a special problem is the recycling of old equipment. For this purpose, nowadays it is customary to take out the plastic part from old equipment, grinding it and mixing it into the new product and so introducing these recycled materials into production again. Not only is the shape of the housings, but also the color of these housings generally subject to a fashion trend. In addition to the former gray and black tones, today, colors are used increasingly, such as yellow, red, blue, etc.

The production of colored housings makes the use of recycled material difficult because the color of such material is subject to great fluctuations. Sorting recycled material according to pure color would be uneconomical, since here every conceivable color tone would occur only in small amounts.

However, there is a possibility to compound colored recycled material with noncolored new product and to determine the color of the compound exactly.

In order to save costs, a method will be indicated which makes it possible to use colored recycled plastic material again in production.

A method is known from WO 00/67977 for sorting and separating plastics. However, it is not disclosed there to consider the original recycled plastics in the creation of the color of products to be made from the original recycled plastics.

The production of a garden fence from plastic waste is known from DE-A1-41 26 694.

The production of new plastic bottles from waste plastic bottles is known from JP-A-08099317.

The recovery of sorted pure plastic from plastic containing mixtures is known from DE-A1-41 29 754.

The task is solved by the characteristics of claim 1. Other advantageous embodiments of the invention are given in the dependent Claims and in the rest of the Specification.

Color formulation is generally understood to mean the determination of the mean coloring agent concentration which is necessary for adjusting the color tone of a model. For color formulation, first the reflection curve of the model is measured exactly. The model consists of a coloring agent which is embedded into a matrix. Calibration series are produced using measurements of samples which contain the coloring agent in the matrix at different concentrations.

Based on these calibration series then, the amount of coloring agent necessary for matching a desired color tone can be calculated.

In the production of colored plastic parts, generally precolored plastic or noncolored plastics and a master batch are used. The task of the master batch is to color the plastic. The problem consists in determining the amount of master batch necessary to achieve the desired color impression. This amount can be calculated with the aid of color-measuring equipment, a color formulation program and the calibration series for this color. In production control, it is determined if the amount of master batch used is sufficient to produce the desired color impression.

Color, which includes black, white and gray tones as so-called noncolored colors, is defined according to DIN 5033:

“Color is that visual sensation of a part of the visual field which appears structureless to the eye, through which alone, upon observation with one eye and without any eye movement, this part can be distinguished from a simultaneously seen, also structureless bordering part.” The purpose of this definition is the delineation of the perception of color in comparison to other sensations, for example, that of a structure or perception of a space.

In order to make an exact determination of the color possible, so-called colorimetric measures are used. The colorimetric measures are obtained by steps of mathematical calculation. For this purpose, measurement of the reflection curve of the sample is necessary. First of all, the light entering the eye is determined. This can be obtained from the radiation distribution of the type of light and that part examined in the sample. Here, the amount of light falling in the eye is the sum of the amount of light over the entire spectrum of visible light, according to the formula:

$$M = {\sum }_{λ} S ( λ ) * R ( λ )$$

Where: S(λ)=radiation distribution of the type of light

R(λ)=reflection curve of the sample

In order to be able to determine the colorimetric measures from the measured values, the color must be reproduced by each wavelength of the three primary colors. The formula for the calculation of the colorimetric measures is as follows:

$$\begin{matrix}X = {\sum }_{λ} S ( λ ) * R ( λ ) * \overline{x} ( λ ) \\ Y = {\sum }_{λ} S ( λ ) * R ( λ ) * \overline{y} ( λ ) \\ Z = {\sum }_{λ} S ( λ ) * R ( λ ) * \overline{z} ( λ )\end{matrix}$$

Here, the equations S(λ), \overline{x}(λ), {overscore (y(λ)}) and z{overscore ((λ)}) is standardized for each type of light and observer (2°, 10°). S(λ)* \overline{x}(λ), S(λ)* \overline{y}(λ), S(λ)* \overline{z}(λ) is collected for each step size. R(λ) is the variable in the measurement to be performed.

The colorimetric measure Y is of special importance here. In the spectral value curves, Y is adjusted to the brightness perception of the eye and it gives the brightness of the sample. Ideally, the values are standardized in such a way that the Y value is 100 in the case of an ideal white sample.

In order to be able to classify the color unequivocally, in addition to the colorimetric measures determined by the observers with a visual field of 2° or 10°, the type of light with which the observation is performed must also be given. Then the determination of the colorimetric measure is carried out as follows:

1. X D65/2

or

2. X₂D65

Here, X is the colorimetric measure and D65 is the type of light.

2 means 2° observer.

The representation of the color is done to represent the technical conditions in a three-dimensional space in a graphic representation. In order to make the graphic representation possible, the three-dimensional space is cut into a brightness step and this cutting plane is used as a standard color plate. Here, the coordinates of this color plate are parts of the colorimetric measures (standard color value parts). The standard color value parts are calculated as follows:

$$\begin{matrix}x = \frac{X}{X + Y + Z} \\ y = \frac{Y}{X + Y + Z}\end{matrix}$$

Here, only two of the three standard color value parts are needed in order to describe a color accurately, since the sum of the standard color value parts is one.

The following applies:

x+y+z=1

Here, normally, the coordinates x and y are used, and usually the third coordinate is omitted, which is perpendicular to the coordinate system and gives the brightness.

In order to calculate the color difference between two colors, each individual locus of the color must be established in the color space. Starting from this, then the distance of two color points in the coordinate system can be calculated.

The calculation is carried out in the calculation of the color difference by starting from a standard sample. The result of the calculation and experiments showed that, in some color loci, a distance of a defined quantity is to be calculated at which no difference in the color can be detected by an observer. Consequently, it was found that the visible difference does not correspond to a color difference of a unit at all loci of a color space. Therefore, the color differences or color impressions are represented as ellipsoids and are taken as such. In order to solve this problem, the so-called CIELAB color space was developed.

The color coordinates of the color space can be recalculated using the following equation:

L*=116Y*−16

a*=500(X*−Y*)

b*=200(Y*−Z*)

The following applies here:

X*=3\sqrt{X/Xₙ} for X/Xₙ>0,008856

X*=7,787*(X/Xₙ)+0,138 for X/Xₙ≦0,008856

Y*=3\sqrt{Y/Yₙ} for Y/Yₙ>0,008856

Y*=7,787*(Y/Yₙ)+0,138 for Y/Yₙ≦0,008856

Z*=3\sqrt{Z/Zₙ} for Z/Zₙ>0,008856

Z*=7,787*(Z/Zₙ)+0,138 for Z/Zₙ≦0,008856

Xₙ, Yₙ, Zₙ correspond to the standard color values [10].

In the CIELAB space, the color difference is calculated using two formulas, which found application especially in industry.

These formulas are as follows:

1. This formula applies for vector calculation:

ΔE*=\sqrt{(ΔL*)²+(Δa*)²+(Δb*)²}

or

2. This formula applies in the case of plotting in cylindrical coordinates

ΔE*=\sqrt{(ΔL*)²+(ΔC*)²+(ΔH*)²}

L* here is the brightness, C* the color strength or saturation, H* the color shade angle or color tone.

As already stated, two color samples which have the same colorimetric measure, can leave an identical color impression a type of light and produce a color impression under a different type of light.[sic] This effect is called metamerism and is mainly dependent on the type of light, that is, on its spectral distribution and on the reflection behavior of the sample.

In color formulation, one must first of all consider the relationship between reflection, coloring agent concentration and color intensity.

The relationship between reflection and scattering as a function of the coloring agent concentration must be clarified, since the color measurement must also be used for the color formulation. Below, in the representation, reference is made only to opaque systems because these are the ones that found special application in industry.

The degree of reflection can be calculated as follows:

R=1+K/S−\sqrt{(1+K/X)²−1}

Here, K is the absorption, S the scattering and R the degree of reflection.

Then, the color intensity must be determined. The color intensity gives the ratio of a sample to a standard which is established as having 100% color intensity.

$$F = \frac{{K}_{PF}}{{K}_{SF}}$$

K_{PF} is the absorption of the sample and K_{SF} is the absorption of the standard.

The concentration of the coloring agent necessary to produce a sample with this color intensity can be calculated from this ratio. The dependence is reciprocal.

However, the formulation cannot be derived from the color intensity alone. In order to reproduce the color sample, the behavior of the pigments at different concentrations must be determined because the measurement gives only the standard color values and the reflection curve. The relationship between reflection, absorption and scattering at a given wavelength can be seen from the following equation:

R=1+K/S−{square root over ((1+K/S²−1)}

Therefore, the relationship for the absorption and scattering for a mixture of different pigments is as follows:

K=K_{M}+K₁*c₁+K₂*c₂

S=S_{M}+S₁*c₁+S₂*c₂

or, generally:

K=K_{M}+ΣKᵢ*cᵢ

S=S_{M}+ΣSᵢ*cᵢ

Based on this relationship, the mixture of pigments can be determined at a given wavelength. The goal is to reach the degree of reflection of the sample.

Since the reflection curve is always valid only for one wavelength, the reflection curve is calculated with the aid of different wavelengths. Here, it must be given that the color difference at the individual wavelengths be within a predetermined tolerance. Then, this must be taken into consideration in the formulation.

The determination of the formulation is illustrated below using a schematic flow chart.

This flow chart is shown in the attached figure FIG.

The flow chart operates as follows:

Reading-in of the calibration series, determination of the reflection curve of the sample and of the coloring agent. This is then followed by selecting the coloring agent for the formulation. The K- and S-values are calculated for the selected coloring agent. Then the initial concentration is calculated. If a negative concentration is obtained here, then one must go back again to the selection of the coloring agent for the formulation. If no negative concentration occurs, or if the value does not lie outside the tolerance, the reflection curves are calculated from the formulation. This is followed by recalculation of the color coefficients of the formulation and the sample.

This is followed by a comparison of the colorimetric measures, to determine if these are within the tolerance. If this is the case, then all possible combinations are calculated. If this is not possible, then one must go back again to the selection of the coloring agent. If the colorimetric measures are outside the tolerance or if the color comparison is not applicable, a new calculation of the concentration is carried out with the aid of the color deviation. One must return to the step of the calculation of the reflection curve from the formulation. After all possible combinations have been calculated, then sorting of the formulations is carried out, followed by issue of the formulation.

Another procedure and another type of method is given by the fact that, by targeted color formulation with colored recycling material, the master batch amount to be used so far for coloration of the new product is replaced by colored ground material. Here, the recycling material must be back-calculated for a mixture of coloring agents and their concentrations in the uncolored plastic.

This back-calculation is necessary since, as it was found so far, a formulation can only be created with the aid of the coloring agent and its coefficients.

At the same time, the problem that the recycling material is delivered by an outside company and thus it is not guaranteed that the coloring agent is identical with the coloring agent, which was used in the preparation of the calibration curves, is avoided. The master batches, which are supposed to produce the very same color, can be different from one color manufacturer to another, and therefore can also have different absorption and scattering coefficients. This, then, would have the consequence that a new calculation would have to be performed for each color of a manufacturer.

If one would wish to avoid this, then each material and each manufactured part should be able to be followed from manufacturer to recycling company to determine what materials are included. An exact log would have to be followed regarding which material with what color is present and in what amount. Then, this information would have to be made available to the customer. This would require very great expenditure for logistics. This problem can be avoided by the back-calculation. The individual colors do not have to be separated any more, and only a defined type of plastic must be delivered.

However, the mixture of size-reduced parts must be homogeneous, so that a constant mixing color is present. Otherwise, color differences would occur. For each color master batch, a so-called calibration series must be prepared. With the aid of such calibration series, two coefficients, for example, the absorption- and scattering coefficients, can be determined, which are necessary for the calculation of the formulation, and the covering power of the color batch must also be determined. The existing ground material is extruded. The granules produced by extrusion cannot be used for direct color measurement because, for this purpose, a plane surface is required. Therefore, the so-called test panels are produced in a tool specially adapted for this.

The test panels, as well as the tool necessary for this, are protected by patent rights of the Applicant under file name DE 197 39 599 C2.

The tool has a square cavity, the two largest rectangular surfaces of which are structured threefold. One-sixth of the surface is polished to a high gloss, two-thirds are smooth and one-sixth has a grained surface.

Furthermore, to illustrate the invention, the teaching of the invention is explained with the aid of a specific practical example. A plastic part with a defined color is to be produced from a technical or thermoplastic plastic. For example, ABS comes into consideration as such a plastic. Waste plastic is used for this purpose. The waste plastic is sorted according to color and type of plastic. These plastic parts are sorted according to a pure color and have a relatively pure color.

In an especially advantageous embodiment of the invention, the plastics are not sorted according to color, but in the mixed form, to a mixed color produced in this way. The plastic parts are homogenized unsorted and then, the color-sorted plastics are reused as described below.

The plastic parts are waste parts which are disassembled from various equipment units or other components and consist only of the defined plastic. These parts are sorted according to color classes and placed in containers. The content of these containers is then ground and stored in the ground state. The ground plastic material is then a plastic with a pure color as long as the presorting makes this possible. For each of these plastic ground products, the color pigments are determined separately for each sorted and ground plastic. After grinding the plastics, a ground plastic material is obtained which has a pure color for each coloring agent. By determination of the color pigments, the ground plastic material is assigned to a color pigment palette.

The target color of the target plastic is known. It is also known which color pigments are necessary to reach the target color.

Based on the target color and the necessary color pigments, a first formulation proposal is made for the composition of the color pigments, which are necessary for producing the target plastic. Then, other formulation proposals are determined.

Using the corresponding spectral reflection curve, especially with the aid of metamerism, that is, based on color differences with computational equality, a formulation proposal is selected from the individual available formulation proposals.

The color pigments necessary for producing the plastics are determined with the aid of the selected formulation proposal. The individual determined color pigments are then assigned to the already existing ground plastic materials. Then the amount and composition of the new plastic to be produced is determined on the basis of the color pigments assigned to the existing ground plastic materials. Then the percentage amount of the individually available amounts of granulates are calculated.

Based on these calculated percentage amounts to be added, the individual available ground plastic components are mixed together according to the formulation, with the aid of a plastic compounding installation. In this way, a plastic with the desired color is produced which is to be used later. The individual waste substances, dosed gravimetrically are plasticized, homogenized and regranulated in the plastic-compounding installation. The plastic obtained in this way can be processed further.

In order to assign the individually existing ground plastic materials to the corresponding color pigment, a homogenized mass is produced from each plastic granulate and a structural part is molded in an injection-molding machine. This structural part is preferably a test panel protected under file No. DE 197 39 599 C2.

Based on this test panel, the individual color pigments of the plastic can be assigned, that is, it can be recalculated to the color pigments which are present in the ground plastic material. If it is found in the setting up of the formulation proposal that the desired target color cannot be achieved with the existing plastic granulates, since either a corresponding color is missing or the ground material is not present in a sufficient amount, then, the target color can be achieved by the addition of color batches. However, this is only a problem of amounts, since the technical realization exists.

Buntheit saturation QV5016vocab

Buntton color shade

Farbabstand color difference

Farbeindruck color impression

Farbenraum color space

Farbmasszahl colorimetric measure

Farbmessgerät color-measuring equipment

Farbmittel coloring agent

Farbstärke color intensity

Forrmteil preform

Farbton color tone

Kunststoffmahlgut ground plastic material

Metamerie metamerism

Nachstellung matching

Normfarbwert standard color value

Reflexionsgrad degree of reflection

Reflexionskurve reflection curve

Remission spectral reflection

Schrittweite step size

Rezepturvorschlag formulation proposal

Testform test molded product

Vorlage model

1. Method for coloring plastics using recycled plastic materials, comprising:
collecting used plastic,
sorting the collected used plastic according to color,
grinding and storing the collected and sorted used plastics or intermediate storing the collected and sorted used plastics,
determining the color pigments which are present in the ground and stored or intermediate-stored plastic,
determining the target color of the new plastics to be produced, and
mixing the used ground plastics in amounts such that the new plastic will have the desired target color.

2. Method according to claim 1, wherein
the used plastics are sorted according to color and the color pigment values are assigned to the ground plastic.

3. Method according to claim 1, wherein
the color of the plastic to be produced is defined according to LAB values.

4. Method according to claim 1, wherein
a formulation proposal is determined for the composition of the color pigments to be used for the production of the target plastic.

5. Method according to claim 1, wherein
the formulation proposal is selected with the aid of the corresponding spectral reflection curve and/or the amount and the composition of the plastic to be created newly on the basis of existing ground waste plastic is done according to the assigned color pigments and/or the percentage amount of the amounts of individual existing granulates to be used is determined.

6. Method according to claim 5, wherein
the individual determined amounts of the components are produced according to the formulation proposal with the aid of a plastic compounding installation.

7. Method according to claim 5, wherein
the ground plastic material mixture is dosed with the aid of a gravimetric dosing installation.

8. Method according to claim 5, wherein
the ground plastic material is plasticized, homogenized and regranulated.

9. Method according to claim 1, wherein
a test molded product is produced from the ground plastic material mixture.

10. Method according to claim 9, wherein
the test molded product is a test panel.

11. Method according to claim 1, wherein
calibration series are produced and that these and that, with the aid of these calibration series, coefficients can be determined for the ground plastic materials and/or absorption and scattering coefficients can be determined.

12. Method according to claim 1, wherein
the determination of the color of the ground plastic material is done by establishing a colorimetric measure with the aid of the formula,
$$M = {\sum }_{λ} S ( λ ) * R ( λ )$$
where S(λ) is the radiation distribution of the type of light and R(λ) is the reflection curve of the plastic.

13. Method according to claim 1, wherein
the reflection curve of the ground plastic material is determined with the aid of a sample of the ground plastic material from which the test panel is produced.

14. Method according to claim 1, wherein
the color is produced at each wavelength of the three primary colors and that the colorimetric measure is determined for each primary color, where the colorimetric measures are calculated as follows:
$$\begin{matrix}X = {\sum }_{λ} S ( λ ) * R ( λ ) * \overline{x} ( λ ) \\ Y = {\sum }_{λ} S ( λ ) * R ( λ ) * \overline{y} ( λ ) \\ Z = {\sum }_{λ} S ( λ ) * R ( λ ) * \overline{z} ( λ )\end{matrix}$$
where S(λ{overscore (), x)} (λ{overscore (),)} y (λ) an\overline{d} z (λ) are standardized for each type of li\overline{g}ht and \overline{o}bserve\overline{r}(2°,10°) and S(λ)*x(λ),S(λ)* y(λ), S(λ)* z(λ) are determined at each step size and R(λ) is variable.

15. Method according to claim 1, wherein
the values for the colorimetric measure are standardized in such a way that the colorimetric measure has the value 100 for the value of Y in the case of a white sample.

16. Method according to claim 1, wherein
the degree of reflection of the sample is determined, which is calculated as follows:
R=1+K/S−\sqrt{(1+K/S)²−1}
where K is the absorption, S the scattering and R the degree of reflection.

17. Method according to claim 1, wherein
the color intensity of the sample is determined, where the color intensity is established in relation to a standard value which is present as 100% color intensity and/or the degree of reflection of the sample is determined and/or the degree of reflection of the sample is determined for different wavelengths of the incident light.
